(19) United States
(12) Patent Application Publication
(10) Pub. No.: US 2008/0199008 A1
(43) Pub. Date: Aug. 21, 2008

(54) Image forming device and image forming method

(75) Inventor: Hiroshi Hattori, Fuwa-gun (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/071,434

(22) Filed: Feb. 21, 2008

(30) Foreign Application Priority Data
Feb. 21, 2007 (JP) 2007-041096

(51) Int. Cl. H04N 1/44; G06F 17/00

(52) U.S. Cl. 380/243; 380/51

(57) ABSTRACT

An image forming device, to which an external storage is detachably connected, is provided with a first password acquiring unit configured to acquire a password input by a user when print data is to be encrypted, and an encrypting unit configured to encrypt the print data in accordance with the password acquired by the first password acquiring unit and store the encrypted print data in the external storage. The image forming device is further provided with a second password acquiring unit configured to acquire a password input by the user when the encrypted print data is to be printed, a decrypting unit configured to decrypt the encrypted print data in accordance with the password acquired by the second password acquiring unit, and a printing unit configured to print the print data which is encrypted by the encrypting unit and then decrypted by the decrypting unit.

### CROSS-REFERENCE TO RELATED APPLICATION

This application claims priority under 35 U.S.C. § 119 from Japanese Patent Application No. 2007-041096 filed on Feb. 21, 2007. The entire subject matter of the application is incorporated herein by reference.

### BACKGROUND

1. Technical Field

The following description relates to an image forming device capable of performing direct printing for reading print data from an external storage detachably connected to the image forming device and printing the print data.

2. Related Art

Conventionally, there has been known an image forming device capable of performing direct printing. The direct printing is a function of retrieving print data stored in the external storage such as a USB (Universal Serial Bus) memory detachably attached to the image forming device, developing the print data into image data (e.g., bitmap data), and printing images on recording sheets based on the developed image data.

When the print data is stored in the external storage, in order to preserve confidentiality, the print data may be encrypted. When the direct printing is performed, the external storage storing the encrypted print data is connected to the image forming device. Then, the image forming device decrypts the encrypted print data and executes a printing operation in accordance with the decrypted print data. An example of such an image forming device is disclosed in Japanese Patent Provisional Publications No. 2004-249598 (hereafter, referred to as '598 publication), No. 2005-130261 (hereafter, referred to as '261 publication) and No. 2006-72754 (hereafter, referred to as '754 publication)

### SUMMARY OF THE INVENTION

According to '598 publication or '261 publication, the image forming device receives print data of which security is preserved from a personal computer via the network. Then, the image forming device encrypts the received print data using a predetermined encryption key and stores the encrypted print data in the external storage. With this configuration, the image forming device should be connected to the personal computer via the network. Further, in order to decryption, the external storage should be connected to the same image forming device which encrypts the image data. Therefore, the image forming devices disclosed in '598 publication or '261 publication are low in versatility thereof.

According to '754 publication, the external storage is connected to a personal computer, and print data created in the personal computer is encrypted therein, and stored in the external storage by the personal computer. Therefore, in order to encrypt the print data, the personal computer is required.

In consideration of the above problem, the present invention is advantageous in that an improved image forming device is provided, with which security of the print data can be preserved and versatility can be realized.

According to aspects of the invention, there is provided an image forming device to which an external storage is detachably connectable. The image forming device is provided with a first password acquiring unit configured to acquire a password input by a user when print data is to be encrypted, and an encrypting unit configured to encrypt the print data in accordance with the password acquired by the first password acquiring unit and store the encrypted print data in the external storage. Thus, the image forming device is capable of encrypting the print data and storing the encrypted print data in the external storage. The image forming device is further provided with a second password acquiring unit configured to acquire a password input by the user when the encrypted print data is to be printed, a decrypting unit configured to decrypt the encrypted print data in accordance with the password acquired by the second password acquiring unit, and a printing unit configured to print the print data which is encrypted by the encrypting unit and then decrypted by the decrypting unit. Thus, the image forming device is capable of decrypting the print data encrypted and stored in the external device.

According to further aspects of the invention, there is provided an image forming device to which an external storage is detachably connectable, which is provided with an encrypting unit configured to encrypt the print data in accordance with a first password and store the encrypted print data in the external storage, a second password acquiring unit configured to acquire a password when the encrypted print data is to be printed, a decrypting unit configured to decrypt the encrypted print data in accordance with a second password, and a printing unit configured to print the print data which is to be encrypted by the encrypting unit and then decrypted by the decrypting unit.0

According to aspects of the invention, there is provided a method of printing print data for an image forming device to which an external storage is detachably connectable. The method includes the steps of first acquiring a password input by a user when print data is to be encrypted, and encrypting the print data in accordance with the password acquired by the first acquiring step and storing the encrypted print data in the external storage. The method further includes the steps of second acquiring a password input by the user when the encrypted print data is to be printed, decrypting the encrypted print data in accordance with the password acquired by the second acquiring step, and printing the print data which is encrypted by the encrypting step and then decrypted by the decrypting step.

According to aspects of the invention, there is provided a computer accessible recording medium storing a program which causes an image forming device to execute the method described above.

With the above configuration, security of the print data can be preserved and versatility of the print data stored in the external storage can be realized.

### BRIEF DESCRIPTION OF THE ACCOMPANYING DRAWINGS

FIG. 1 is a perspective view of an image forming device according to aspects of the invention.

FIG. 2 is a block diagram showing an electrical configuration of the image forming device according to aspects of the invention.

FIG. 3 is flowchart illustrating an encryption process according to aspects of the invention.

FIG. 4 is a flowchart illustrating a direct print process according to aspects of the invention.

FIG. 5 shows an image displayed on a displaying unit when file(s) to be encrypted is (are) selected.

FIG. 6 shows a relationship between a name of an original print data file and a name of an encrypted print data.

### DETAILED DESCRIPTION OF THE EMBODIMENT

Hereinafter, referring to the accompanying drawings, an image forming device according to an embodiment will be described in detail.

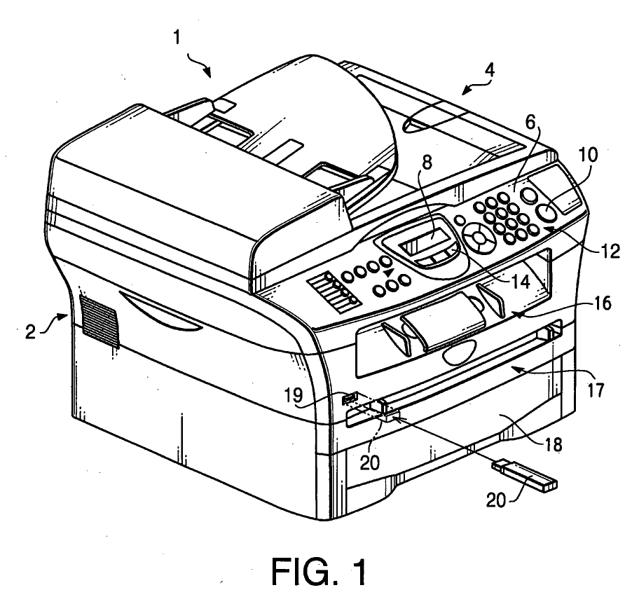

FIG. 1 is a perspective view of an appearance of an image forming device 1 according to an embodiment of the invention. The image forming device 1 is a so-called MFP (Multi-Function Peripheral) having printer function, scanner function, facsimile function and copier functions.

As shown in FIG. 1, the image forming device 1 is provided with an image forming unit 2 and an image scanning unit 4. On an upper surface of the image forming device 1, an operation unit 6 provided with a plurality of operable keys, a displaying unit 8 for displaying information on an LCD (Liquid Crystal Display) is provided. In particular, the operation unit 6 is provided with an execution key 10 which is operated to execute a selected function, ten keys 12 for inputting numerals, and function selection keys 14 for selecting one of the functions available to the image forming device 1.

Below the operation unit 6, a sheet pickup opening 16 communicated from a sheet discharge tray is formed. Below the sheet pickup opening 16, a manual sheet feed opening 17 which is a slit extending in a horizontal direction. Further, below the manual sheet feed opening 17, a sheet feed cassette 18 is provided. On a front surface of the image forming device 1, an insertion slot 19 to which the external storage 20 is detachably connected is formed.

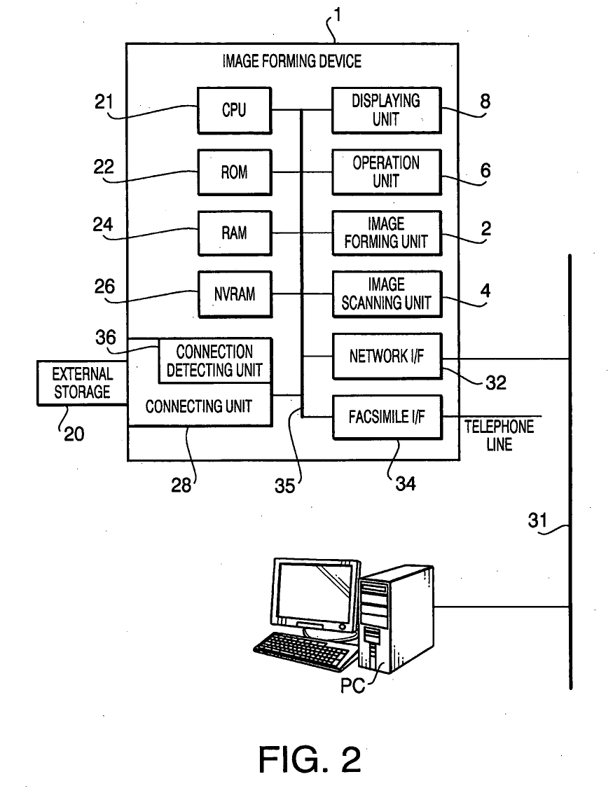

FIG. 2 is a block diagram showing an electrical configuration of the image forming device 1. The image forming device 1 is provided with a CPU (Central Processing Unit) 21 which executes programs to control operation of the image forming device 1, a ROM (Read Only Memory) 22 storing various programs to be executed by the CPU 21, a RAM (Random Access Memory) 24 which temporarily stores data such as processing results, an NVRAM (Non-Volatile RAM) 26 which retains data even if power supply is off.

The image forming device 1 further includes a connecting unit 28 to which the external storage 20 is connected, the operation unit 6, the displaying unit 8, an image forming unit 2 which is controlled by the CPU 21 based on the programs and forms images on the recording sheets, and a network interface 32 which is configured to connect the image forming device 1 to external devices such as a PC (Personal Computer) or the like through a network, and a facsimile interface 34 for connecting the image forming device 1 to the public telephone network. The above-described units are interconnected through a bus 35 such that data can be exchanged thereamong.

The connecting unit 28 is provided with a connection detecting unit 36 which has a well-known configuration for detecting connection/disconnection of the external storage 20 by monitoring signal level of a terminal, which is in a disconnected status when the external storage 20 is not connected to the connecting unit 28, while in a connected status when the external storage 20 is connected to the connecting unit 28.

According to the exemplary embodiment, the external storage 20 is a handy USB (Universal Serial Bus) memory provided with a non-volatile rewritable memory. The USB memory can be removably connected to the image forming device 1, that is, the external storage 20 can be removably connected to the connecting unit 28. It should be noted that the external storage 14 need not be the USB memory, but any medium which can be removably connected to the image forming device 1 and data can be retrieved therefrom or written therein. Thus, alternatively or optionally, a floppy Disk®, an external hard disk, magneto-optical disc drive, or a non-volatile memory card can be used as the external storage 20.

The printing operation is executed by the image forming unit 2 in accordance with a well-known electrophotographic imaging process. That is, a laser beam is ON/OFF modulated based on the image data and scanned within a predetermined angular range so that the surface of a photoreceptive drum, which is rotated, is scanned by the modulated laser beam (not shown) to form a electrostatic latent image. The latent image is then developed as toner is applied thereto, thereby a toner image is formed. The toner image is transferred onto a recording sheet which is fed from the sheet feed cassette 18. The toner image transferred on the recording sheet is fixed on the recording sheet, which is discharged and stacked on the discharge tray. As described above, the image forming unit 20 is configured as a so-called page printer, which forms an page of the image (toner image) on one page of the recording sheet. It should be noted that the invention need not be limited to this configuration (i.e., the electrophotographic imaging device), but can be of other types such as an inkjet type serial printer (i.e., not a page printer).

The image scanning unit 4 is configured such that an image of an original document which is placed on a glass plate is scanned by an image sensor through the glass plate.

The image forming device 1 generates the image data by developing print data, which is transmitted from an external PC via the network interface 32 and/or stored in the external storage 20, or a frame memory inside the RAM 24. The image data thus developed in the frame memory of the RAM 24 is transmitted to the image forming unit 2 as CMYK (Cyan, Magenta, Yellow and Black) data or K data (in case of grey-scale image). The image forming unit 2 prints images represented by the image data on the recording sheet. The printing operation may be color printing or monochromatic printing.

The print data is, for example, PDL (Page Description Language) data or a predetermined printable format such as PDF, TIFF, or JPEC format data.

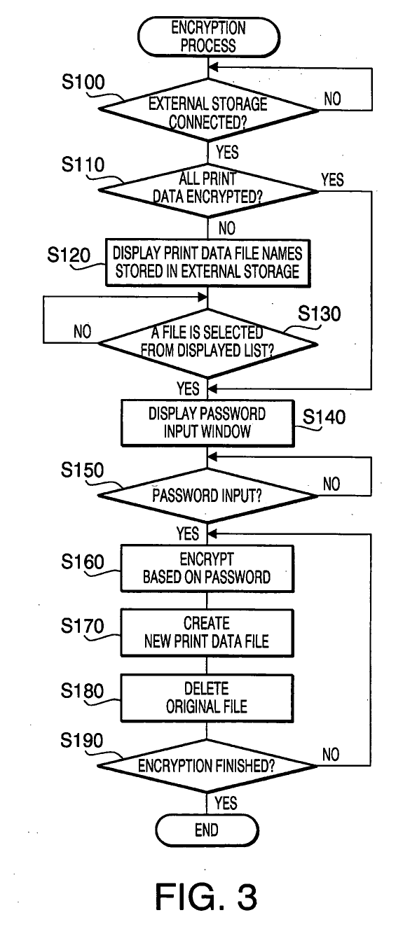

Next, an encryption process executed by the image forming device 1 will be described. FIG. 3 is a flowchart illustrating the encryption process. The encryption process is executed when a user operates the selection key 14 to select an “encryption” menu from among functional menus displayed on the displaying unit 8 and then operates the execution key 10. It should be noted that the external storage 20 should be connected to the insertion slot 19 before the encryption process is started.

It should be noted that, before the encryption process is executed, the print data (which is not encrypted) should be stored in the external storage 20 in advance. Storing the print data in the external storage 20 is done by the external device (PC) when the external storage 20 is connected to the external device (PC). It should be noted that the external device need not be connected to the image forming device 1 via the network 31.

For example, when application software such as a word processing application, a spreadsheet application, an image processing application or the like installed in the external device is executed, if a print menu of the application is selected by the user, and “output to file” is selected in the menu, the print data is stored in the external storage 20. The print data file is the PDL data file or a file suitable to the direct print (e.g., PDF, TIFF, JPEG, etc.).

That is, after creating text data, spreadsheet data etc. with applications (word processing application, spreadsheet application, etc.) of an external PC, the user may select a print menu of the application, and selects printing. Then, the text data, spreadsheet data, etc. are converted into the PDL data by the printer driver software. The thus converted PDL data is stored in the external storage 20 as described above.

A PDF data can also be used. The PDF is a file format developed by Adobe system and widely used format. The PDF contains not only text, image information, but layout information, font information and the like and enables the direct printing without relying on an application. Further, the image file formats such as the TIFF format and JPEG format can be used as the data file format and are stored as they are when the print data is stored in the external device 20. If the image forming device 1 is implemented with font data, a so-called text type print data can also be subject to the direct printing. Therefore, in such case, the print data of a TXT format may be stored in the external storage 20.

When the print data is stored in the external storage 20, without the external PC, images represented by the print data can be printed by the image forming device 1 capable of executing the direct printing. That is, for printing images represented by the print data stored in the external storage 20, the user may remove the external storage 20 from the external PC, and connects the external storage 20 to the image forming device 1.

The image scanning unit 4 may be used to create the print data. That is, image data is obtained by scanning an original document placed on the original-placing glass using the image scanning unit 4, and the thus obtained image data may be stored in the external storage 20 as the print data. Further, the image data received by the facsimile interface 34 via the public telephone network may be stored in the external storage 20 as the print data.

When the user operates the selection keys 14 and execution key 10 and selects the “encryption process” from the menu displayed on the displaying unit 8, the encryption process shown in FIG. 3 is executed.

When the encryption process is started, the process firstly judges whether the external storage 20 is connected to the connecting unit 28 (S100). As described above, the judgment in S100 is made based on the detection by the connection detecting unit 36. If the external storage 20 is not connected to the connecting unit 28 (S100: NO), the process stays in S100 until the external storage 20 is connected to the connecting unit 28.

When the process judges that the external storage 20 is connected to the connecting unit 28 (S100: YES), the process judges whether all the pieces of the print data stored in the external storage 20 are to be encrypted (S110). The function menu may include “encrypt all data” and “encrypt selected data” as a sub menu of “encryption process” which may also be selected, for example, by the user by operating the selection key 14.

When the “encrypt selected data” has been selected (S110: NO), the process displays file names of the print data files stored in the external storage 20 on the display unit 8 (S120). Then, the process judges whether one or more of the print data files as displayed are selected (S130).

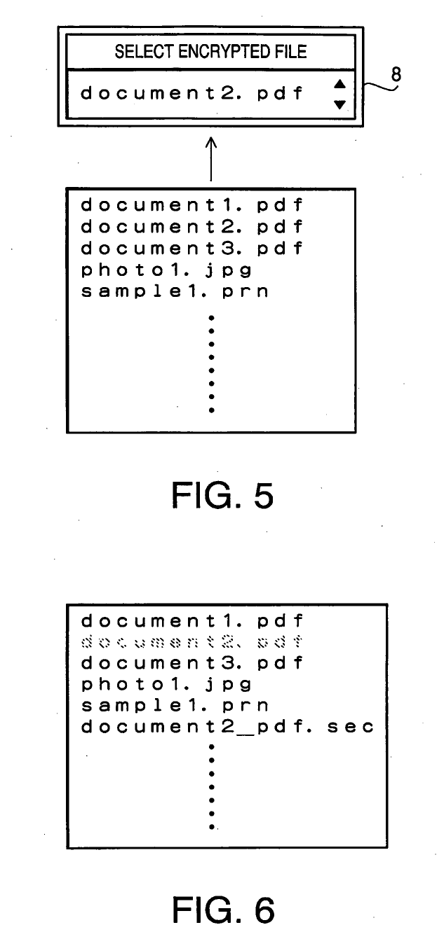

According to the embodiment, the print data files are displayed on the display unit 8 as shown in FIG. 5. That is, according to this exemplary embodiment, one or two file names of the print data files stored in the external storage 20 are displayed on the display unit 8. As user operates certain keys, the displayed file names are scrolled and preliminarily selected. Then, when the user operates the execution key of the operation unit 10, the selection is established. It should be noted that only a single print data file may be selected, or a plurality of print data files may be selected. If a display area of the display unit 8 is larger, more file names may be displayed.

The process waits until file names are selected (S130: NO). When file names are selected (S130: YES), the process displays a password input window requiring the user to input a password (S140). Alternatively, if “encrypt all data” is selected (S110: YES), the process skips S120 and S130, and displays the password input window (S140). In S140, for example, a character string “PASSWORD:” may be displayed on the display unit 8 and the process waits until the user inputs the password using the ten keys 12 and the like (S150: NO).

When the process judges that the password is input (S150: YES), the process starts encrypting the print data. According to the embodiment, a so-called common key cryptography system is employed, and using the password as a common key, encryption and decryption are performed according to a predetermined cryptography algorithm.

If “encrypt selected data” is selected by the user, one of the selected print data files (if a plurality of pieces print data files are selected, one of them are selected, for example, according to an alphabetical order of the file names) is encrypted (S160). If “encrypt all data” is selected, one of the print data files (if a plurality of pieces print data files are stored, one of them are selected, for example, according to an alphabetical order of the file names) is encrypted (S160).

By encrypting the print data file, a new print data file (encrypted) is generated, which is stored in the external storage 20 (S170). When the encrypted print data file is stored in the external storage 20, the name of the encrypted print data file is determined to show some relationship with respect to the original print data file. For example, the original print data file (non-encrypted) is “document2.pdf,” the new (encrypted) print data file may be “document2_pdf.sec” as indicated in FIG. 6. After the encrypted print data file is stored in the external storage 20, the original print data file is deleted (S180). In the above example, after the “document2_pdf.sec” file is stored, the “document2.pdf” file is deleted.

In S190, the process judges whether the encryption of the print data files is completed. That is, if “encrypt selected data” is selected and only one print data file is selected in S130, the process determines that the encryption is completed (S190: YES) since the selected print data file has been encrypted. In this case, the encryption process is finished.

If “encrypt selected data” is selected and a plurality of print data files are selected in S130, the process repeats S160-180 until all the selected print data files are encrypted, the encrypted files are stored in the external storage 20, and the original print data files corresponding to the encrypted print data files are deleted. When all the selected print data files are processed (S190: YES), the encryption process is finished.

If “encrypt all data” is selected, the process repeats S160-180 until all the print data files are encrypted, the encrypted files are stored in the external storage 20, and the original print data files are deleted. When all the print data files are processed (S190: YES), the encryption process is finished.

In the exemplary embodiment described above, two functions of encrypting all the print data files and encrypting selected data files are available. This configuration can be modified such that only one of the functions is provided. That is, the image processing device may be configured to encrypt all the print data files, or encrypt selected print data files.

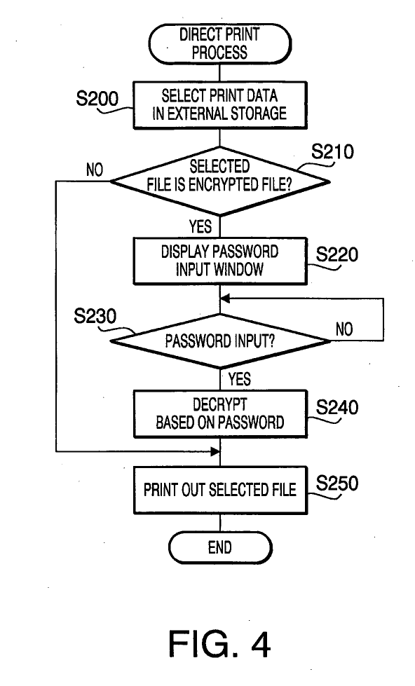

Next, a direct print process will be described. FIG. 4 shows a flowchart illustrating the direct print process according to the embodiment. When the user operates the selection keys 14 and execution key 10 to select “direct print” from the function menus displayed on the display unit 8, the direct print process is executed.

In the direct printing operation, the process displays file names of the print data files stored in the external storage 20 on the displaying unit 8, and requires the user to select print data files to be printed (S200). According to the embodiment, as in encryption process (S120), the process displays one or two file names of the print data files stored in the external storage 20 on the display unit 8 such that the file names can be scrolled, and requires the user to select the print data files to be printed. When the user preliminarily selects the file(s) to be printed and operates the execution key of the operation unit 10, the file(s) is/are selected.

When the file names are displayed, not only the file names of the encrypted print data files, but also those of non-encrypted print data files are displayed. According to an aspect, the file names of the encrypted print data files are displayed initially, and by scrolling the file names, the file names of non-encrypted print data files may be displayed.

When the print data file is selected, the process judges whether the file is an encrypted print data file (S210). This judgment is done, for example, based on the extension of the file name.

If the selected data file is the encrypted print data file (S210: YES), the process displays a password input window on the display unit 8 (S220). In S230, for example, a character string “PASSWORD:” may be displayed on the display unit 8 and the process waits until the user inputs the password using the ten keys 12 and the like (S230: NO).

When the process determines that the password has been input (S230: YES), the process start decrypting the print data based on the input password, and stores the decrypted print data in the RAM 24 (S240).

After decryption of the encrypted print data file (S240) or if the selected print data file is a non-encrypted print data file (S210: NO), the process prints the selected print data (S250). Specifically, if the selected print data file is the encrypted print data file, the process prints the decrypted print data file stored in the RAM 24. If the selected print data file is the non-encrypted print data file, the process prints the print data file stored in the external storage 20.

When the print data file is printed, the process rasterizes the print data file and develops bit map data (i.e., image data) in a frame memory area in the RAM 24. After developing the image data, the process controls the image forming unit 2 to print images on the recording sheets based on the image data. When the print data file is printed, the direct print process is finished.

When the encrypted print data file is decrypted based on the password, if the input password is different from the password used for encryption, the print data file cannot be correctly decrypted, and therefore, a printing operation is not performed correctly. Therefore, according to the above-described configuration, a third party cannot decrypt the encrypted print data file correctly, thereby security of the print data being preserved.

The encryption/decryption operations are performed in the image forming device 1. Therefore, another external device such as a personal computer is unnecessary. Accordingly, security of the print data can be preserved easily. Further, encryption/decryption can be performed without storing the password or the like in the image forming device 1. Therefore, even if different image forming devices are used for encryption and decryption, it is ensured that the decryption process can be performed. Accordingly, versatility of the encrypted print data files can be improved, and convenient. For example, the encryption is performed using the image forming device at a user's company, and decryption and printout can be done by another image forming device at a branch office or another company, and security of the print data during transporting the external storage 20 is also preserved.

It should be noted that, although the invention is described based on the exemplary embodiment, the invention should not be limited to the configuration of the embodiment. Various modifications can be made without departing from the scope of the invention.

What is claimed is:

1. An image forming device to which an external storage is detachably connectable, comprising:
a first password acquiring unit configured to acquire a password when print data is to be encrypted;
an encrypting unit configured to encrypt the print data in accordance with the password acquired by the first password acquiring unit and store the encrypted print data in the external storage;
a second password acquiring unit configured to acquire a password when the encrypted print data is to be printed;
a decrypting unit configured to decrypt the encrypted print data, which is stored in the external storage, in accordance with the password acquired by the second password acquiring unit; and
a printing unit configured to print the print data which is encrypted by the encrypting unit and then decrypted by the decrypting unit.

2. The image forming device according to claim 1, wherein the print data to be encrypted is preliminarily stored in the external storage.

3. The image forming device according to claim 1,
further comprising an image scanning unit configured to scan an image on a document and output image data representing the scanned image,
wherein the print data includes the image data output by the image scanning unit.

4. The image forming device according to claim 1,
further comprising a facsimile unit configured to receive image data via a telephone line,
wherein the print data includes the image data received by the facsimile unit.

5. The image forming device according to claim 1,
wherein the encrypting unit deletes the print data after the print data is encrypted and stored in the external storage.

6. The image forming device according to claim 1,
wherein the print data includes a plurality of print data files, and
wherein the encrypting unit is configured to allow the user to select a print data file to be encrypted.

7. The image forming device according to claim 1,
wherein the print data includes a plurality of print data files, and
wherein the encrypting unit is configured to encrypt all the print data files.

8. The image forming device according to claim 1,
wherein the encrypted print data includes a plurality of encrypted print data files, and
wherein the decrypting unit is configured to allow the user to select an encrypted print data file to be decrypted.

9. The image forming device according to claim 1, further comprising a display unit configured to display a message for requiring the password when the print data to be printed is the encrypted data encrypted by the encrypting unit.

10. An image forming device to which an external storage is detachably connectable, comprising:
an encrypting unit configured to encrypt the print data in accordance with a first password and store the encrypted print data in the external storage;
a second password acquiring unit configured to acquire a password when the encrypted print data is to be printed;
a decrypting unit configured to decrypt the encrypted print data in accordance with a second password; and
a printing unit configured to print the print data which is to be encrypted by the encrypting unit and then decrypted by the decrypting unit.

11. The image forming device according to claim 10, further comprising:
a first password acquiring unit which acquires the first password; and
a second password acquiring unit which acquires the second password,
wherein the encrypting unit encrypts the print data in accordance with the first password, and
wherein the decrypting unit decrypts the print data in accordance with the second password.

12. The image forming device according to claim 11, further comprising a display,
wherein the display displays a first message for requiring the first password when the first password acquiring unit acquires the first password, and
wherein the display displays a second message for requiring the second password when the second password acquiring unit acquires the second password.

13. A method of printing print data for an image forming device to which an external storage is detachably connectable, comprising the step of:
first acquiring a password input by a user when print data is to be encrypted;
encrypting the print data in accordance with the password acquired by the first acquiring step and storing the encrypted print data in the external storage;
second acquiring a password input by the user when the encrypted print data is to be printed;
decrypting the encrypted print data in accordance with the password acquired by the second acquiring step; and
printing the print data which is encrypted by the encrypting step and then decrypted by the decrypting step.

14. The method according to claim 13,
further comprising a step of deleting the print data after the print data is encrypted and stored in the external storage.

15. The method according to claim 13,
wherein the print data includes a plurality of print data files, and
wherein the step of encrypting including a step of allowing the user to select a print data file to be encrypted.

16. The method according to claim 13,
wherein the print data includes a plurality of print data files, and
wherein the step of encrypting encrypts all the print data files.

17. The method according to claim 13,
wherein the encrypted print data includes a plurality of encrypted print data files, and
wherein the step of decrypting includes a step of allowing the user to select an encrypted print data file to be decrypted.

18. A computer accessible recording medium storing a program which causes an image forming device to execute the steps of:
first acquiring a password input by a user when print data is to be encrypted;
encrypting the print data in accordance with the password acquired by the first acquiring step and storing the encrypted print data in an external storage which is detachably connected to the image forming device;
second acquiring a password input by the user when the encrypted print data is to be printed;
decrypting the encrypted print data in accordance with the password acquired by the second acquiring step; and
printing the print data which is encrypted by the encrypting step and then decrypted by the decrypting step.
